(19) United States
(12) Patent Application Publication
(10) Pub. No.: US 2017/0308836 A1
(43) Pub. Date: Oct. 26, 2017

(54) HIERARCHICAL VISUALIZATION FOR DECISION REVIEW SYSTEMS

(71) Applicant: Accenture Global Solutions Limited, Dublin (IE)

(72) Inventor: Alex M. Kass, Palo Alto, CA (US)

(21) Appl. No.: 15/136,182

(22) Filed: Apr. 22, 2016

(51) Int. Cl. G06Q 10/06; G06N 99/00; G06F 3/0484

(52) U.S. Cl. CPC G06Q 10/06375; G06F 3/0484; G06N 99/005

(57) ABSTRACT

Techniques are described for presenting a hierarchical arrangement of node evaluation results to facilitate the review of a decision. Machine learning (ML) and/or artificial intelligence (AI) techniques are employed to automatically determine an individual result for each of multiple decision nodes that are hierarchically arranged to contribute to an overall result of a decision. A user interface may present the decision nodes and individual results, in their hierarchical arrangement, to enable a reviewer to provide feedback regarding one or more of the individual results and/or the overall result. The reviewer feedback may be employed to further refine the model used to determine the individual results for the decision nodes.

### BACKGROUND

In various types of organizations, decisions may be made regarding the operations and/or business processes of the organization. An organization may operate computing systems that execute decision engines that are programmed with artificial intelligence routines or other types of algorithms to automatically make decisions. Such automated decision engines may access input data and analyze the data to determine a result of the decision. However, traditional decision engines may output the result without any reasons as to why the particular result was determined. Because traditional decision engines may fail to provide visibility into the decision making process, traditional decision engines may make it difficult or impossible to improve the decision making process to enable higher confidence in the decision results.

### SUMMARY

Implementations of the present disclosure are generally directed to automated decision-making and the review of decision results. More specifically, implementations are directed to a visualization system that presents a hierarchical arrangement of decision nodes and node evaluation results to facilitate the review of a decision that includes multiple sub-decisions indicated by the multiple decision nodes.

In general, innovative aspects of the subject matter described in this specification can be embodied in methods that includes actions of: receiving input data associated with the decision; applying a machine learning (ML) algorithm to individually determine a node evaluation result for each of a plurality of decision nodes based on a portion of the input data, the plurality of decision nodes includes in a decision hierarchy for the decision; determining an overall result based on traversing the decision hierarchy according to the node evaluation results; presenting the overall result and the node evaluation results in a reviewer user interface (UI); receiving reviewer feedback to modify at least one of the node evaluation results, the reviewer feedback provided through the reviewer UI; and determining a modified overall result based on applying the decision hierarchy to the node evaluation results including the modified at least one node evaluation result.

Implementations can optionally include one or more of the following features: the ML algorithm further determines a confidence metric indicating a level of confidence in the node evaluation result for each of the decision nodes; the confidence metric for each of the node evaluation results is presented in the reviewer UI; the overall result is a binary result; receiving training data including a plurality of labeled portions of the training data; the actions further include applying the ML algorithm to the training data to generate a model for determining the node evaluation result for each of the decision nodes in the decision hierarchy; the model is employed by the ML algorithm to individually determine the node evaluation result for each of the decision nodes based on the portion of the input data; the actions further include adjusting the model based on the reviewer feedback; the reviewer feedback indicates approval or disapproval of at least one of the node evaluation results; the node evaluation results are presented in at least one of a graphical format or a textual format in a reviewer UI; the node evaluation results are presented in an arrangement according to the decision hierarchy; the reviewer UI presents the node evaluation results in an interactive session; and/or the reviewer feedback is received during the interactive session.

Other implementations of any of the above aspects include corresponding systems, apparatus, and computer programs that are configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

Implementations of the present disclosure provide one or more of the following advantages. By employing feedback information provided through the presentation and review of a hierarchical arrangement of node evaluation results, implementations enable the refinement and improvement of the results of an automated decision making process that employs machine learning (ML), artificial intelligence (AI), and/or other automation. Moreover, the feedback information may also be used to refine and improve the model(s) employed by an automated decision engine to evaluate a decision, and thus improve the operations of traditional computing devices employed in automated decision making. By refining, improving, or otherwise enhancing the decision results and/or the models used to evaluate a decision, implementations provide a technical improvement over traditional decision engines. In particular, implementations provide for an automated decision engine that is more accurate, more efficient, and configured to operate while consuming less processor and/or memory resources compared to traditional decision engines. Moreover, because implementations facilitate efficient review of decisions through presentation of hierarchical arrangement of node evaluation results, implementations also provide for review systems that consume less processor and/or memory resources compared to traditional systems that provide less efficient decision review functionality. Moreover, implementations enable a reviewer to make better use of their time by allowing them to identify and focus in on likely trouble spots quickly, make a judgement about the degree of certainty of the automated results, and improve metrics and/or dimensions that involve combining the automated intelligence with human intelligence and review.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system for decision review including hierarchical visualization, according to implementations of the present disclosure.

FIG. 2 is a schematic depicting an example set of hierarchically arranged decision nodes and a corresponding set of node evaluation results, according to implementations of the present disclosure.

FIG. 3 is a schematic depicting an example of a node evaluation result determined for a decision node based on a model, according to implementations of the present disclosure.

FIG. 4A depicts an example user interface for graphically presenting a hierarchical arrangement of node evaluation results, according to implementations of the present disclosure.

FIG. 4B depicts an example user interface for textually presenting a hierarchical arrangement of node evaluation results, according to implementations of the present disclosure.

FIG. 5 depicts a flow diagram of an example process for generating models, according to implementations of the present disclosure.

FIG. 6 depicts a flow diagram of an example process for decision review, according to implementations of the present disclosure.

FIG. 7 depicts an example computing system, according to implementations of the present disclosure.

### DETAILED DESCRIPTION

Implementations of the present disclosure are directed to systems, devices, methods, and computer-readable media for presenting a hierarchical arrangement of node evaluation results to facilitate the review of a decision. In some implementations, machine learning (ML) techniques or other types of artificial intelligence (AI) may be employed to automatically make a decision within an organization. For example, ML techniques may be employed to make a decision whether to approve or disapprove a loan application based on an analysis of applicant information. The overall result (e.g., approve or disapprove the loan) may be based on a hierarchically arranged set of decision nodes, and each of the decision nodes may be an individual decision. An automated process may evaluate each of the individual decision nodes, and the hierarchy (e.g., a tree) of decision nodes may be traversed according to the individual node evaluation results to determine the overall result.

In traditional systems, the overall result may be provided as an output of the automated decision process, and a reviewer wishing to review the decision may have limited or no visibility into the individual decisions that contributed to the overall result. Accordingly, a traditional system may make it difficult for a reviewer to review a decision and have confidence that the result is appropriate. Moreover, a traditional system may make it difficult for a reviewer to provide meaningful feedback regarding the individual decisions that contributed to the overall result, given that the reviewer may lack visibility into the individual decisions.

Implementations described herein provide a user interface (UI) that a reviewer may access to review the decision making process. The UI may present a hierarchical visualization of the individual node evaluation results that contributed to the overall result, to enable the reviewer to identify the particular decision nodes that contributed to the overall result. In some implementations, the UI may also present for one or more decision nodes a confidence metric that indicates a level of confidence (e.g., from 0% to 100%) in the individual node evaluation result for the node as determined by the automated process. Presenting confidence metrics may enable a reviewer to readily identify the particular nodes where the automated process exhibited uncertainty, and enable the reviewer to adjust the individual results as appropriate.

The UI may enable a reviewer to analyze and provide feedback to adjust the individual node evaluation results. The UI may also enable the reviewer to request a reevaluation of the overall result based on the adjusted individual node results. In some implementations, the reviewer's feedback may also be employed to retrain, refine, or otherwise modify one or more models employed by the automated (e.g., ML) process to determine the individual node evaluation results. By presenting a hierarchical view of the results of the automated decision making process, implementations provide the reviewer with a clearer view of why a particular overall decision result was reached than is provided by traditional systems that may only present the overall result.

In some implementations, each of the nodes represents a sub-problem to be solved by machine learning and/or other techniques that may produce results that are, to some extent, opaque. For example, machine learning and/or other techniques may produce a result that solves the problem or sub-problem, but the result may not provide an explanation for the reasoning that led to the result. Because the relationships between the nodes can be identified, implementations may provide an explanation of the final result in terms of the various decision nodes that contribute to the final result, even though in instances where there is no explanation available for each of the individual results of the decision nodes.

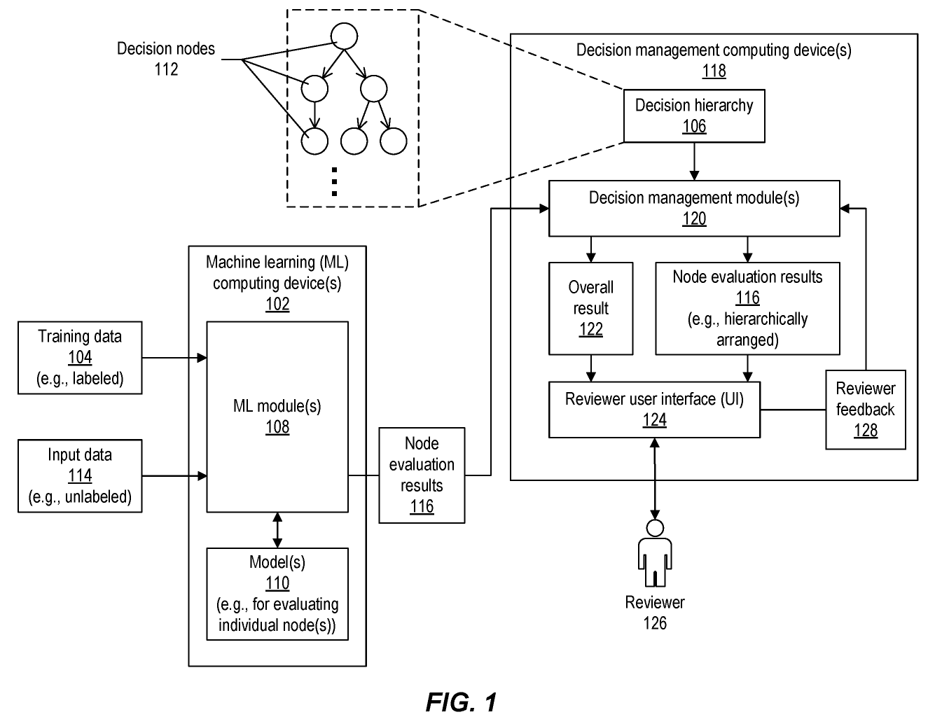

FIG. 1 depicts an example system for decision review including hierarchical visualization, according to implementations of the present disclosure. As shown in the example of FIG. 1, the system may include one or more ML computing devices 102. The ML computing device(s) 102 may include any type of computing device(s), such as server computers, distributed computing devices (e.g., cloud computing servers), and so forth. The ML computing device(s) 102 may execute one or more ML modules 108 that are configured to apply ML techniques for automated decision making. Implementations support the use of any ML techniques, including supervised and/or unsupervised ML techniques.

During a training and/or learning phase, the ML module(s) 108 may be configured to determine models 110. Each of the models 110 may be employed to evaluate a particular decision node 112 and generate a node evaluation result 116 for that decision node 112. In some examples, a model 110 may be employed to evaluate multiple decision nodes 112. The ML module(s) 108 may receive or otherwise access training data 104. In some implementations, the training data 104 may be labeled (e.g., manually) to indicate individual node evaluation results 116 to be output based on the training data 104. For example, trainers may generate training data 104 that is labeled, such as 1000 mortgage applications labeled as accept or reject overall and/or labeled for individual node-level decisions.

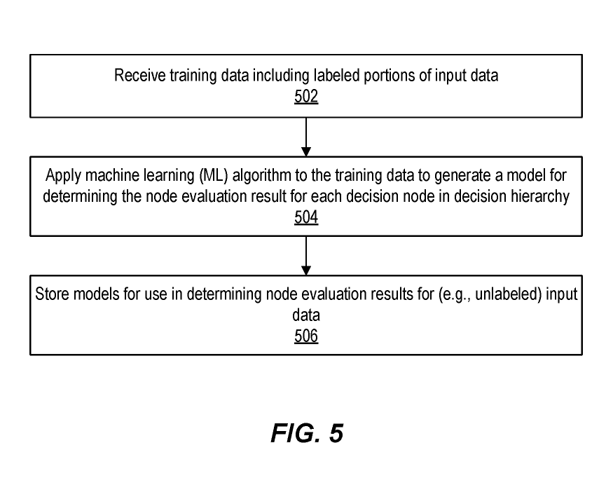

The ML module(s) 108 may employ ML technique(s) to generate the models 110 based on the labeled training data 104. The models 110 may be stored on the ML computing device(s) 102 or elsewhere, and may subsequently be employed by the ML module(s) 108 to analyze unlabeled input data 114. The process of determining the models 110 by applying ML techniques to labeled training data 104 may be described as training and/or learning, and is described further with reference to FIG. 5.

The ML module(s) 108 may determine a node evaluation result 116 for each of a plurality of decision nodes 112 by applying the previously determined models 110 to unlabeled input data 114 for a decision to be made. The ML module(s) 108 may communicate the node evaluation results 116 to one or more decision management modules 120 executing on one or more decision management computing devices 118. The decision management computing device(s) 118 may include any type of computing device(s), such as server computers, distributed computing devices (e.g., cloud computing servers), and so forth. In some implementations, the decision management computing device(s) 118 and the ML computing device(s) 102 may be included in a same set of devices that are configured to execute both the ML module(s) 108 and the decision management module(s) 120.

The decision management module(s) 120 may access a decision hierarchy 106 associated with a decision to be made. The decision hierarchy 106 may describe, for a particular overall decision, a list of decision nodes 112 that are each associated with an individual decision that contributes to the overall decision. The decision hierarchy 106 may also describe any number of relationships between individual decision nodes 112. The decision nodes 112 and the relationships between decision nodes 112 may constitute an ordered graph (e.g., a hierarchical tree) to be traversed to determine an overall result 122 for the decision. The decision management module(s) 120 may traverse the decision hierarchy 106 based on the individual node evaluation results 116 to determine the overall result 122 of the decision.

For example, The node evaluation result 116 of node A may indicate that node B or node C is to be evaluated next, the result of node C may indicate that node D is to be evaluated based on the result of node C, and so forth. The decision nodes 112 may include branch nodes and leaf nodes. The evaluation of a branch node may lead to the evaluation of one or more other nodes based on the result of evaluating the branch node. The evaluation of a leaf node may not lead to the evaluation of other nodes. Accordingly, a leaf node may be a terminus of the traversal of the hierarchy. Determining the overall result 122 of a decision may include traversing the hierarchy of decision nodes 112 along a path that is dictated by the node evaluation results 116 of the individual decision nodes 112 and the logic of the decision nodes 112 themselves. Traversal may continue until a leaf node is reached that indicates the overall result 122 of the decision.

In some implementations, the decision hierarchy 106 for a particular decision may be generated by a hierarchy builder module (not shown). The hierarchy builder module may automatically generate a decision hierarchy 106 for a particular decision. In some example, the hierarchy builder module may enable an operator to manually specify the decision hierarchy 106.

The decision hierarchy 106 may be stored on the decision management computing device(s) 118 or elsewhere such that it is accessible by the decision management module(s) 120 and the reviewer UI 124.

The decision management module(s) 120 may provide the overall result 122 for presentation in a reviewer UI 124 that executes on the decision management computing device(s) 118 or elsewhere. The decision management module(s) 120 may also arrange the node evaluation results 116 into a hierarchical arrangement corresponding to the decision hierarchy 106, and provide the hierarchically arranged node evaluation results 116 for presentation in the reviewer UI 124. The overall result 122 and the hierarchically arranged node evaluation results 116 may be presented in the reviewer UI 124 to a reviewer 126, to provide the reviewer 126 with a detailed view of the manner in which the overall result 122 was reached according to the decision hierarchy and the individual node evaluation results 116.

The reviewer 126 may also employ the reviewer UI 124 to provide reviewer feedback 128. For example, the reviewer 126 may note that a particular node evaluation result 116 was determined for a particular decision node 112. The reviewer 126 may select the node evaluation result 116 in the reviewer UI 124 and the reviewer UI 124 may present information regarding the individual decision at that decision node 112. The reviewer UI 124 may also present, for a selected node, the particular portion of the input data 114 that was used to make the individual decision. The reviewer 126 may use the reviewer UI 124 to alter the individual decision. The reviewer 126 may review any number of individual decision nodes in this manner, and the reviewer UI 124 may generate reviewer feedback 128 indicating the adjustments made to the various node evaluation result(s) 116. In some implementations, the reviewer UI 124 may present, for each decision node 112, a confidence metric indicating a level of confidence in the node evaluation result 116 as determined by the ML module(s) 108. The confidence metric may guide the reviewer 126 to those nodes for which the ML module(s) 108 were uncertain, and the reviewer 126 may review and potentially adjust those nodes.

In some implementations, the reviewer feedback 128 may be provided to the decision management module(s) 120, which may re-traverse the decision hierarchy 106 according to the updated node evaluation results 116 and produce an updated overall result 122. The updated overall result 122 may differ from the previous overall result 122, or may be the same. The reviewer UI 124 may present the updated overall result 122 along with the hierarchically arranged updated node evaluation results 116 to enable the reviewer 126 to make further adjustments if appropriate. The reviewer 126 may perform any number of iterations of review and/or updates until the reviewer 126 is satisfied with the overall result 122.

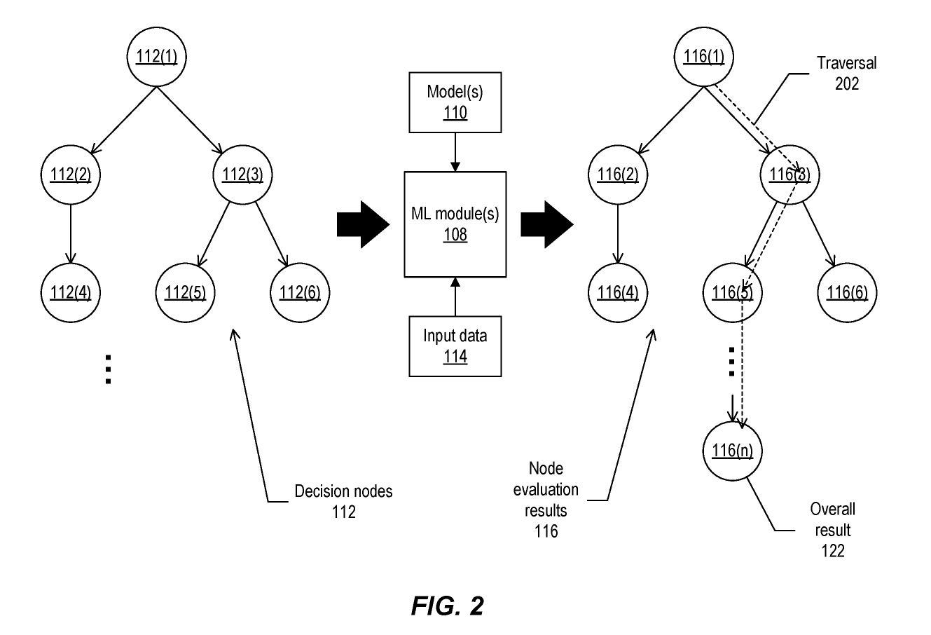

FIG. 2 is a schematic depicting an example set of hierarchically arranged decision nodes 112 and a corresponding set of node evaluation results 116, according to implementations of the present disclosure. As shown in FIG. 2, the hierarchical arrangement of decision nodes 112 may each be evaluated by the ML module(s) 108 by applying a model 110 to the input data 114. The ML module(s) 108 may output node evaluation results 116, including a node evaluation result 116 for each of the decision nodes 112. The decision management module(s) 120 may arrange the node evaluation results 116 into a hierarchical arrangement, according to the decision hierarchy 106, for presentation in the reviewer UI 124. The decision management module(s) 120 may perform a traversal 202 of the hierarchical arrangement of nodes according to the decision hierarchy 106 and the individual node evaluation results 116, and determine an overall result 122 based on the traversal 202.

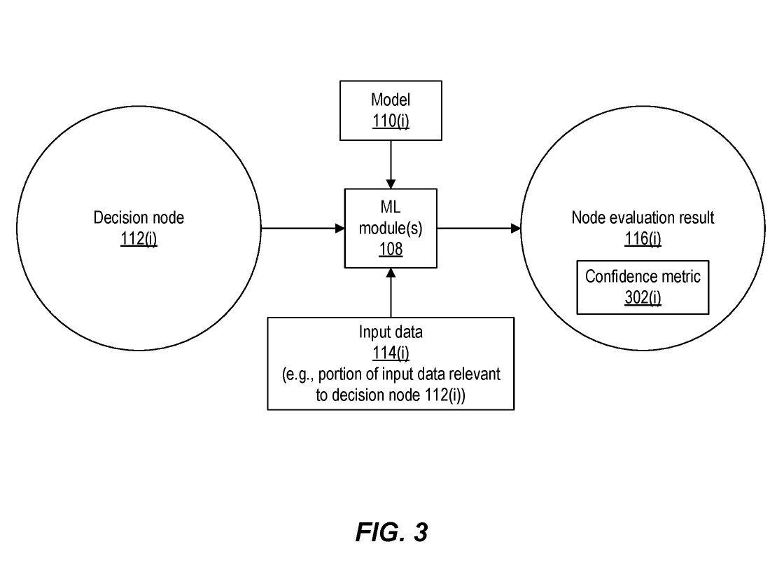

FIG. 3 is a schematic depicting an example of a node evaluation result 116 determined for a decision node 112 based on applying a model 110 to at least a portion of the input data 114, according to implementations of the present disclosure. The individual node evaluation result 116 may be determined by applying a model 110 to at least the portion of the input data 114 that is relevant to the particular individual decision associated with the decision node. As shown in the example, the model 110 may also enable the ML module(s) 108 to determine a confidence metric 302 that indicates a level of confidence in the node evaluation result 116. For example, the confidence metric 302 may range from 0% to 100% confidence, where a higher metric indicates higher confidence in the node evaluation result 116.

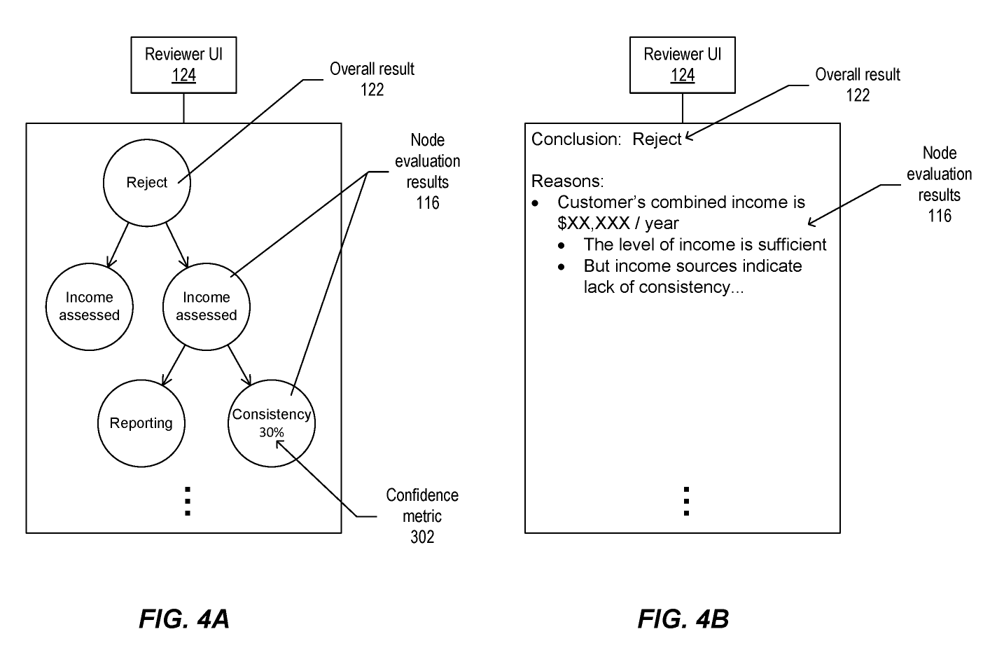

FIG. 4A depicts an example reviewer UI 124 for graphically presenting a hierarchical arrangement of node evaluation results 116, according to implementations of the present disclosure. As shown in this example, the reviewer UI 124 may present the overall result 122 as well as the individual node evaluation results 116 for individual decision nodes 112 in the decision hierarchy 106, e.g., as an ordered graph of individual results. In some implementations, the reviewer UI 124 may also present, for one or more node evaluation results 116, a confidence metric 302 indicating a level of confidence in the node evaluation result 116.

FIG. 4B depicts an example reviewer UI 124 for textually presenting a hierarchical arrangement of node evaluation results 116, according to implementations of the present disclosure. As shown in this example, the reviewer UI 124 may present a plain language or natural language summary of the overall result 122 and/or the individual node evaluation results 116. The summary may indicate the hierarchical arrangement of node evaluation results 116 using indentation, bullet points, arrows, and/or other textual indicators.

In some implementations, the reviewer UI 124 includes control(s) to enable the reviewer 126 to select whether to view a graphical or textual presentation of the overall result 122 and node evaluation results 116. In some examples, the reviewer UI 124 may present the overall result 122 and node evaluation results 116 using some combination of graphical and textual elements. For example, the reviewer 126 may select a node evaluation result 116 by clicking on a node in a graphical display, and the reviewer UI 124 may respond by presenting textual details regarding the selected node, a more detailed description of the node evaluation result 116, the confidence metric 302, the input data 114 that was used to determine the selected node evaluation result 116, Reviewer looks at either text explanation and/or graphical explanation and so forth.

For example, the reviewer UI 124 may present the results of a decision regarding a loan application, and the overall result 122 may initially be to deny the loan. The overall result 122 may have been determined based on a hierarchy of individual results based on one or more of: evaluation of the various sources of income for the loan applicant; whether the applicant reported income in each source; whether the amount of reported income meets a threshold requirement; whether the applicant's reported income for each source is consistent from month to month; the debts currently held by the applicant; the property of the applicant; the current credit lines of the applicant; and so forth. The automated process may have initially denied the loan based on an inconsistent source of income. The reviewer 126 may select the particular decision node for income consistency, and view details that indicate the employer for that source of income. The reviewer 126 may have access to information that indicates the particular employer is a trusted employer, such that income inconsistency may not be as important a factor as in other situations.

Accordingly, the reviewer 126 may adjust the particular node evaluation result 116 and use the reviewer UI 124 to instruct the decision management module(s) 120 to re-evaluate the overall result 122 based on the adjusted node evaluation result(s) 116.

FIG. 5 depicts a flow diagram of an example process for generating model(s) 110, according to implementations of the present disclosure. Operations of the process may be performed by one or more of the ML module(s) 108, the decision management module(s) 120, the reviewer UI 124, or other software module(s) executing on the ML computing device(s) 102, the decision management computing device(s) 118, or elsewhere.

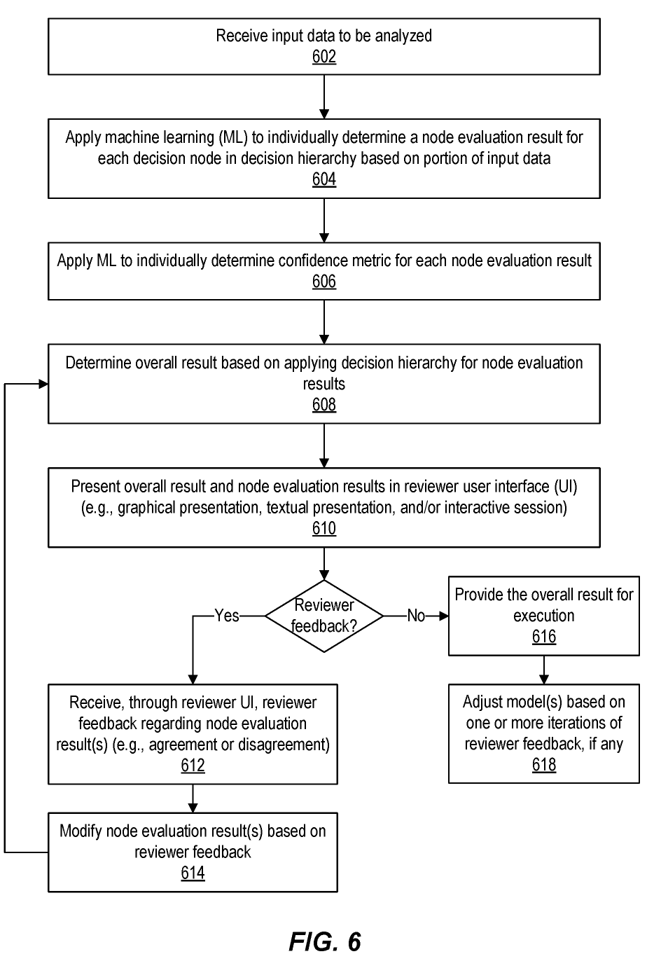

During a training and/or learning phase, the ML module(s) 108 may receive (502) training data 104 including labeled portions of data relevant to individual nodes of a decision hierarchy 106. ML algorithm(s) may be applied (504) to the training data 104 to generate a model 110 for determining the node evaluation result 116 for each of one or more decision nodes 112 in a decision hierarchy 106. The model(s) 110 may be stored (506) for use in determining the node evaluation results 116 for (e.g., unlabeled input data 114, as described with reference to FIG. 6.

FIG. 6 depicts a flow diagram of an example process for decision review, according to implementations of the present disclosure. Operations of the process may be performed by one or more of the ML module(s) 108, the decision management module(s) 120, the reviewer UI 124, or other software module(s) executing on the ML computing device(s) 102, the decision management computing device(s) 118, or elsewhere.

Input data 114 may be received (602) for analysis. As described above, ML algorithm(s) may be applied (604) to individual determine a node evaluation result 116 to each decision node 112 in a decision hierarchy 106, based on at least a portion of the input data 114. In some implementations, the ML algorithm(s) may also be applied (606) to determine a confidence metric 302 for each node evaluation result 116. The overall result 122 may be determined (608) based on traversing or otherwise applying the decision hierarchy 106 based on the individual node evaluation results 116.

The overall result 122 and the node evaluation results 116 may be presented (610) in a reviewer UI 124 to enable a reviewer 126 to provide feedback as described above. If there is reviewer feedback 128, the reviewer feedback 128 may be received (612) through the reviewer UI 124. As described above, the reviewer feedback 128 may include the reviewer's indication that at least one node evaluation result 116 is to be modified. The node evaluation result(s) 116 may be modified accordingly (614) based on the reviewer feedback 128, and the process may re-determine (608) the overall result 122 based on the modified node evaluation result(s) 116. The process may iterate in this manner until the reviewer 126 indicates that there is no further reviewer feedback 128. At that point, the (e.g., final) overall result 122 may be provided for execution within the organization. In some implementations, the model(s) 110 may be adjusted (618) based on the one or more iterations of reviewer feedback 128 to modify node evaluation results 116. In this way, the reviewer feedback 128 may be described as additional training data that may be used to retrain, refine, or other modify the model(s) 110. The reviewer 126 may provide as many iterations of reviewer feedback 128 as desired to achieve an appropriate set of node evaluation results 116. Accordingly, implementations may provide an interactive session in which the reviewer 126 interacts with the reviewer UI 124 over multiple iterations of modifying node evaluation results 116 and re-determining the overall result 122.

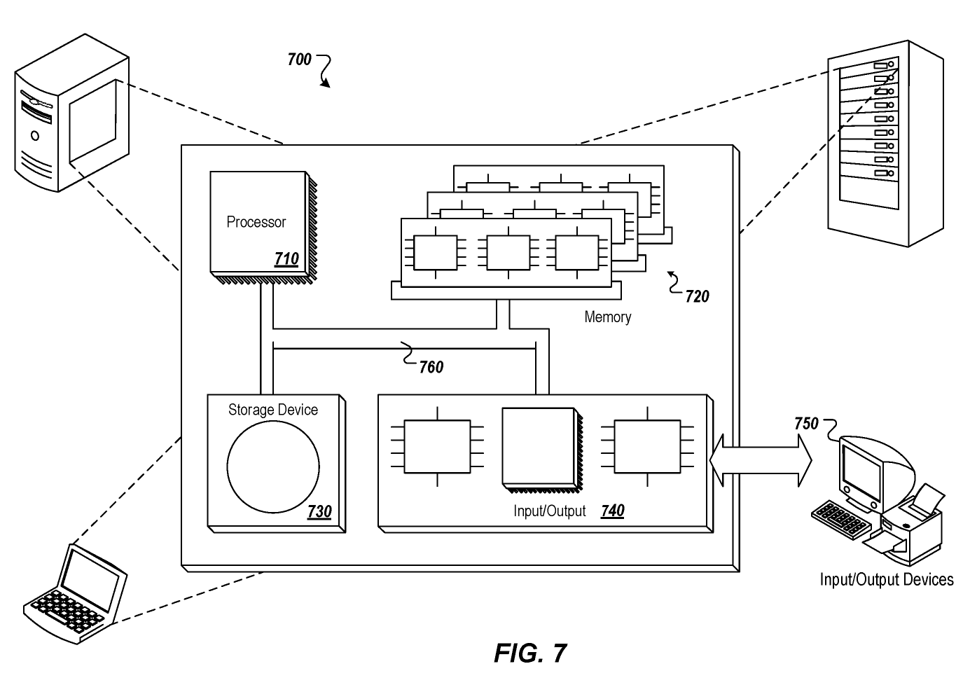

FIG. 7 depicts an example computing system, according to implementations of the present disclosure. The system 700 may be used for any of the operations described with respect to the various implementations discussed herein. For example, the system 700 may be included, at least in part, in one or more of the ML computing device(s) 102 or the decision management computing device(s) 118 described herein. The system 700 may include one or more processors 710, a memory 720, one or more storage devices 730, and one or more input/output (I/O) devices 750 controllable via one or more I/O interfaces 740. The various components 710, 720, 730, 740, or 750 may be interconnected via at least one system bus 760, which may enable the transfer of data between the various modules and components of the system 700.

The processor(s) 710 may be configured to process instructions for execution within the system 700. The processor(s) 710 may include single-threaded processor(s), multi-threaded processor(s), or both. The processor(s) 710 may be configured to process instructions stored in the memory 720 or on the storage device(s) 730. The processor(s) 710 may include hardware-based processor(s) each including one or more cores. The processor(s) 710 may include general purpose processor(s), special purpose processor(s), or both.

The memory 720 may store information within the system 700. In some implementations, the memory 720 includes one or more computer-readable media. The memory 720 may include any number of volatile memory units, any number of non-volatile memory units, or both volatile and non-volatile memory units. The memory 720 may include read-only memory, random access memory, or both. In some examples, the memory 720 may be employed as active or physical memory by one or more executing software modules.

The storage device(s) 730 may be configured to provide (e.g., persistent) mass storage for the system 700. In some implementations, the storage device(s) 730 may include one or more computer-readable media. For example, the storage device(s) 730 may include a floppy disk device, a hard disk device, an optical disk device, or a tape device. The storage device(s) 730 may include read-only memory, random access memory, or both. The storage device(s) 730 may include one or more of an internal hard drive, an external hard drive, or a removable drive.

One or both of the memory 720 or the storage device(s) 730 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 700. In some implementations, the CRSM may include a data store that provides storage of computer-readable instructions or other information in a non-transitory format. The CRSM may be incorporated into the system 700 or may be external with respect to the system 700. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 710 and the memory 720 may be supplemented by, or incorporated into, one or more application-specific integrated circuits (ASICs).

The system 700 may include one or more I/O devices 750. The I/O device(s) 750 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 750 may also include one or more output devices such as a display, LED(s), an audio output device (e.g., a speaker), a printer, a haptic output device, and so forth. The I/O device(s) 750 may be physically incorporated in one or more computing devices of the system 700, or may be external with respect to one or more computing devices of the system 700.

The system 700 may include one or more I/O interfaces 740 to enable components or modules of the system 700 to control, interface with, or otherwise communicate with the I/O device(s) 750. The I/O interface(s) 740 may enable information to be transferred in or out of the system 700, or between components of the system 700, through serial communication, parallel communication, or other types of communication. For example, the I/O interface(s) 740 may comply with a version of the RS-232 standard for serial ports, or with a version of the IEEE 1284 standard for parallel ports. As another example, the I/O interface(s) 740 may be configured to provide a connection over Universal Serial Bus (USB) or Ethernet. In some examples, the I/O interface(s) 740 may be configured to provide a serial connection that is compliant with a version of the IEEE 1394 standard.

The I/O interface(s) 740 may also include one or more network interfaces that enable communications between computing devices in the system 700, or between the system 700 and other network-connected computing systems. The network interface(s) may include one or more network interface controllers (NICs) or other types of transceiver devices configured to send and receive communications over one or more networks using any network protocol.

Computing devices of the system 700 may communicate with one another, or with other computing devices, using one or more networks. Such networks may include public networks such as the internet, private networks such as an institutional or personal intranet, or any combination of private and public networks. The networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 700 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for automated determination of an overall result for a decision, the method comprising:
receiving input data associated with the decision;
applying a machine learning (ML) algorithm to individually determine a node evaluation result for each of a plurality of decision nodes based on a portion of the input data, the plurality of decision nodes includes in a decision hierarchy for the decision;
determining an overall result based on traversing the decision hierarchy according to the node evaluation results;
presenting the overall result and the node evaluation results in a reviewer user interface (UI);
receiving reviewer feedback to modify at least one of the node evaluation results, the reviewer feedback provided through the reviewer UI; and
determining a modified overall result based on applying the decision hierarchy to the node evaluation results including the modified at least one node evaluation result.

2. The method of claim 1, wherein:
the ML algorithm further determines a confidence metric indicating a level of confidence in the node evaluation result for each of the decision nodes; and
the confidence metric for each of the node evaluation results is presented in the reviewer UI.

3. The method of claim 1, wherein the overall result is a binary result.

4. The method of claim 1, further comprising:
receiving training data including a plurality of labeled portions of the training data; and
applying the ML algorithm to the training data to generate a model for determining the node evaluation result for each of the decision nodes in the decision hierarchy;
wherein the model is employed by the ML algorithm to individually determine the node evaluation result for each of the decision nodes based on the portion of the input data.

5. The method of claim 4, further comprising:
adjusting the model based on the reviewer feedback.

6. The method of claim 1, wherein the reviewer feedback indicates approval or disapproval of at least one of the node evaluation results.

7. The method of claim 1, wherein:
the node evaluation results are presented in at least one of a graphical format or a textual format in a reviewer UI; and
the node evaluation results are presented in an arrangement according to the decision hierarchy.

8. The method of claim 1, wherein:
the reviewer UI presents the node evaluation results in an interactive session; and
the reviewer feedback is received during the interactive session.

9. A system, comprising:
at least one processor; and
a memory communicatively coupled to the at least one processor, the memory storing instructions which, when executed by the at least one processor, cause the at least one processor to perform operations comprising:
receiving input data associated with the decision;
applying a machine learning (ML) algorithm to individually determine a node evaluation result for each of a plurality of decision nodes based on a portion of the input data, the plurality of decision nodes includes in a decision hierarchy for the decision;
determining an overall result based on traversing the decision hierarchy according to the node evaluation results;
presenting the overall result and the node evaluation results in a reviewer user interface (UI);
receiving reviewer feedback to modify at least one of the node evaluation results, the reviewer feedback provided through the reviewer UI; and
determining a modified overall result based on applying the decision hierarchy to the node evaluation results including the modified at least one node evaluation result.

10. The system of claim 9, wherein:
the ML algorithm further determines a confidence metric indicating a level of confidence in the node evaluation result for each of the decision nodes; and
the confidence metric for each of the node evaluation results is presented in the reviewer UI.

11. The system of claim 9, wherein the overall result is a binary result.

12. The system of claim 9, the operations further comprising:
receiving training data including a plurality of labeled portions of the training data; and
applying the ML algorithm to the training data to generate a model for determining the node evaluation result for each of the decision nodes in the decision hierarchy;
wherein the model is employed by the ML algorithm to individually determine the node evaluation result for each of the decision nodes based on the portion of the input data.

13. The system of claim 12, further comprising:
adjusting the model based on the reviewer feedback.

14. The system of claim 9, wherein the reviewer feedback indicates approval or disapproval of at least one of the node evaluation results.

15. One or more computer-readable media storing instructions which, when executed by at least one processor, cause the at least one processor to perform operations comprising:
receiving input data associated with the decision;
applying a machine learning (ML) algorithm to individually determine a node evaluation result for each of a plurality of decision nodes based on a portion of the input data, the plurality of decision nodes includes in a decision hierarchy for the decision;
determining an overall result based on traversing the decision hierarchy according to the node evaluation results;
presenting the overall result and the node evaluation results in a reviewer user interface (UI);
receiving reviewer feedback to modify at least one of the node evaluation results, the reviewer feedback provided through the reviewer UI; and
determining a modified overall result based on applying the decision hierarchy to the node evaluation results including the modified at least one node evaluation result.

16. The one or more computer-readable media of claim 15, wherein:
the ML algorithm further determines a confidence metric indicating a level of confidence in the node evaluation result for each of the decision nodes; and
the confidence metric for each of the node evaluation results is presented in the reviewer UI.

17. The one or more computer-readable media of claim 15, wherein the overall result is a binary result.

18. The one or more computer-readable media of claim 15, the operations further comprising:
receiving training data including a plurality of labeled portions of the training data; and
applying the ML algorithm to the training data to generate a model for determining the node evaluation result for each of the decision nodes in the decision hierarchy;
wherein the model is employed by the ML algorithm to individually determine the node evaluation result for each of the decision nodes based on the portion of the input data.

19. The one or more computer-readable media of claim 15, wherein:
the node evaluation results are presented in at least one of a graphical format or a textual format in a reviewer UI; and
the node evaluation results are presented in an arrangement according to the decision hierarchy.

20. The one or more computer-readable media of claim 15, wherein:
the reviewer UI presents the node evaluation results in an interactive session; and
the reviewer feedback is received during the interactive session.
